(19) United States
(12) Patent Application Publication
(10) Pub. No.: US 2004/0052073 A1
(43) Pub. Date: Mar. 18, 2004

(54) Flashlight assembly

(76) Inventors: Chia-Ching Chang, Changhua (TW); Tung-Feng Wu, Changhua City (TW); Chien-Ping Lien, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/243,765

(22) Filed: Sep. 16, 2002

(51) Int. Cl. F21L 4/00

(52) U.S. Cl. 362/197; 362/191; 362/398; 362/199

(57) ABSTRACT

A flashlight assembly includes a body having a battery received therein and an end cap assembly including a magnetic member is connected to a first end of the body. Two slots are defined through a second end of the body and two terminal plates are connected to an inside of the second end of the body. A gap is defined between the two terminal plates. A handle has an engaging portion which is pivotably connected to the second end of the body and two insertions extend through the two slots. One of the two insertions is located below the two terminal plates. A light bulb assembly is pivotably connected to the engaging portion of the handle. The two terminal plates are pushed to contact with other by the insertion when the handle is pivoted and the contact of the two terminal plates form a circuit.

### FIELD OF THE INVENTION

The present invention relates to a flashlight assembly which has a pivotable handle and a body with a bulb. The handle is lifted to activate the bulb. A magnetic plate is connected to an end of the body so as to be fixed on a metal surface.

### BACKGROUND OF THE INVENTION

A conventional flashlight generally includes a hollow tubular body with batteries received therein and a head is connected to an end of the body. A light bulb is received in the head and is connected to a positive end of the batteries. A cap is connected to the other end of the body and contacts the negative end of the batteries so that when operating a switch, the light bulb lights up. The flashlight is so convenient for the user to carry and provides light to a distance where light is needed. Nevertheless, the user has to hold the flashlight by one hand so as to aim the light beam at the desired position or spot. This limits the user to use both of his or her hands. Besides, the user has to push the switch to light up the bulb and this requires an additional action for his or her fingers.

The present invention intends to provide a flashlight assembly that is easily to light up by simply lifting the handle.

### SUMMARY OF THE INVENTION

In accordance with one aspect of the present invention, there is provided a flashlight assembly which comprises a body having a battery received therein and an end cap assembly is connected to a first end of the body. Two slots are defined through a second end of the body and two terminal plates are connected to an inside of the second end of the body. A gap is defined between the two terminal plates. A handle has an engaging portion which is pivotably connected to the second end of the body and two insertions of the engaging portion extend through the two slots. One of the two insertions is located below the two terminal plates. A light bulb assembly is pivotably connected to the engaging portion of the handle. The two terminal plates contact with each other by one of the insertions when lifting the handle.

The primary object of the present invention is to provide a flashlight that is operated simply by lifting the handle and the flashlight has a magnetic member which is convenient to fix the flashlight on a metal surface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the flashlight assembly of the present invention;

FIG. 2 is an exploded view to show the flashlight assembly of the present invention;

FIG. 3 is a cross sectional view to show the flashlight assembly of the present invention;

FIG. 4 shows two insertions are inserted in the two slots in the second end of the body of the flashlight assembly of the present invention;

FIG. 5 shows the light bulb assembly is pivoted relative to the body;

FIG. 6 shows another view of the pivotal movement of the light bulb assembly, and

FIG. 7 shows the flashlight is secured on a metal surface of the magnetic member.

### DETAILED DESCRIPTION OF THE PREFERRED EMBODIMENT

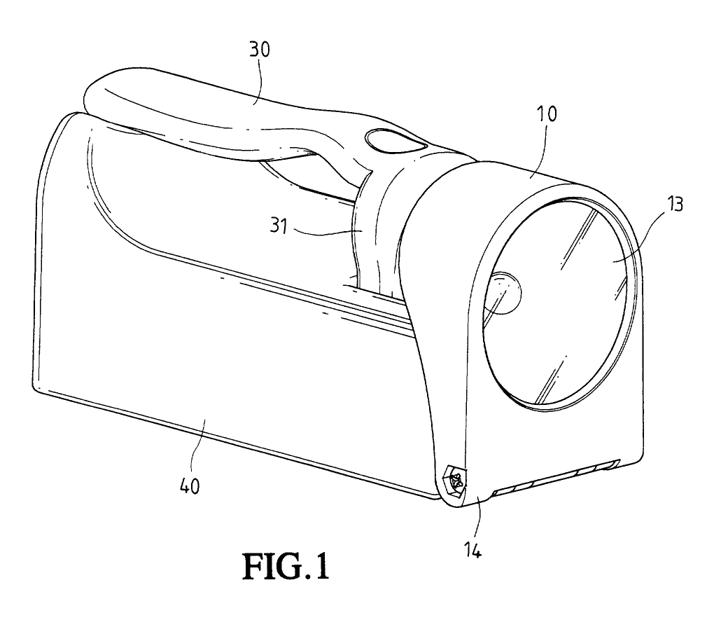

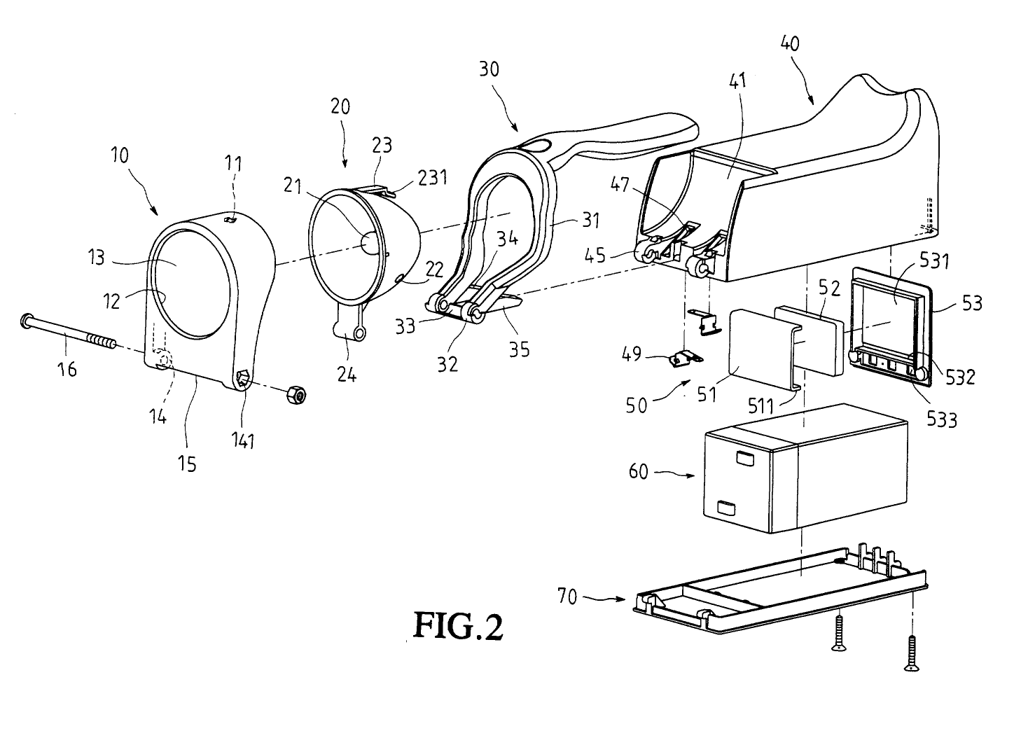

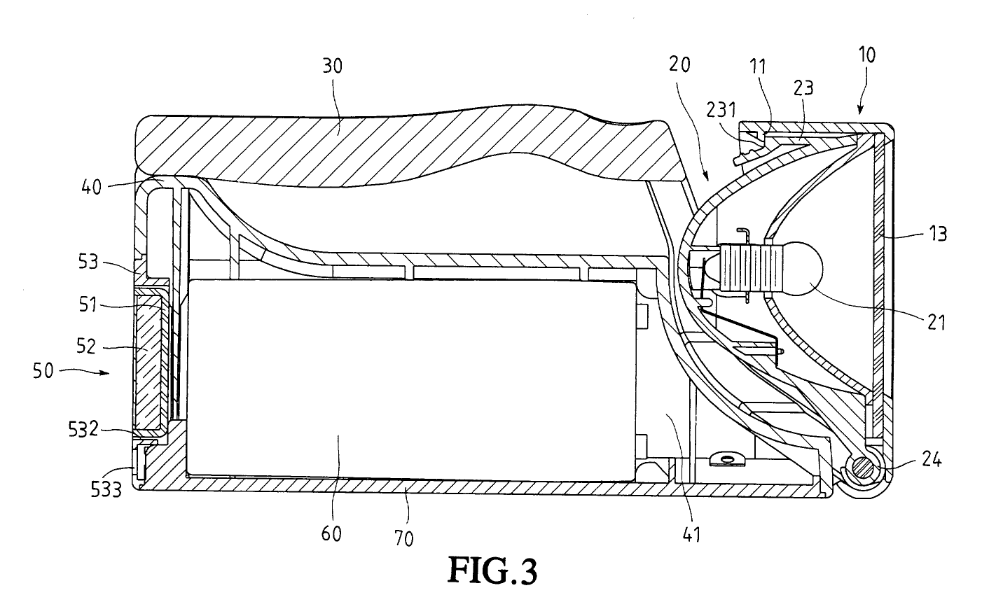

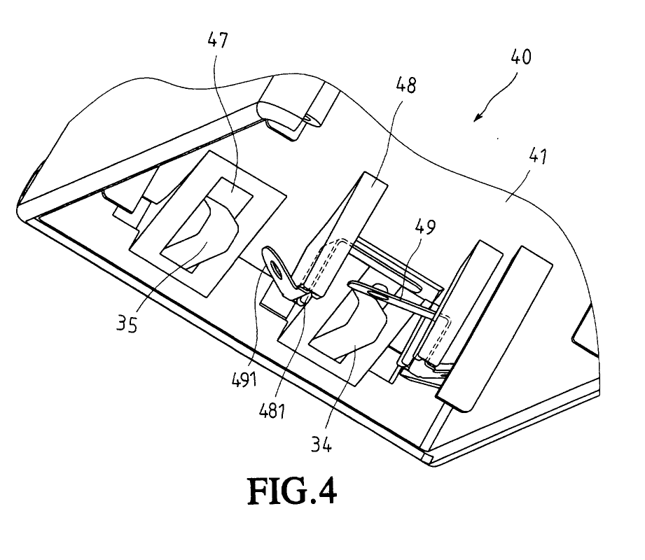

Referring to FIGS. 1 to 4, the flashlight assembly of the present invention comprises a body 40 having a battery 60 received therein from an open bottom of the body 40 and a bottom plate 70 is engaged with the open bottom of the body 40. An end cap assembly 50 is connected to a first end of the body 40 and includes a retaining plate 51, an end cap 53 and a magnetic member 52 which is positioned between the retaining plate 51 and the end cap 53. The end cap 53 has an end plate 531 and two slits 532 are defined in an inside of the end cap 53. The retaining plate 51 has two flanges 511 which are inserted in the two slits 532 and the magnetic member 52 is retained between the two flanges 511 and the end plate 531. Several charging holes 533 are defined through the end cap 53 so as to be connected to a charging kit (not shown) via the charging holes 533 when charging the flashlight.

Two slots 47 are defined through a wall 41 in a second end of the body 40 and two engaging pieces 48 are connected to an inside of the wall 41 of the body 40. Two terminal plates 49 are inserted through two respective slots 481 in the engaging pieces 48 and each terminal plate 49 has a wire connection end 491. Wires (not shown) may extend through a hole 43 defined through the wall 41 and are connected to the two wire connection ends 491. A gap is defined between the two terminal plates 49.

A handle 30 has an engaging portion 31 which has two lugs 32 and a connection plate 33 is connected between the two lugs 32. The two lugs 32 are pivotably connected to two lugs 45 extending from the second end of the body 40. Two insertions 34, 35 extend from the engaging portion 31 and through the two slots 47. One of the two insertions 34, 35 is located below the two terminal plates 49.

A light bulb assembly is pivotably connected to the engaging portion 31 of the handle 30 and includes a reflection member 20 with a bulb 21 connected thereto and a frame 10 which is detachably connected to the reflection member 20. The frame 10 has a glass 13 engaged with a hole 12 in the frame 10. The reflection member 20 has a wire hole 22 for the wires inserted therein to be connected with the bulb 21. A resilient tab 23 is connected to an outside of the reflection member 20 and has a stepped portion 231. A protrusion 11 extends from an inside of the frame 10 and is engaged with the stepped portion 231 of the resilient tab 23. When pushing the resilient tab 23, the stepped portion 231 is disengaged from the protrusion 11 so that the frame 10 can be detached from the reflection member 20. An extension portion 24 of the reflection member 20 is pivotably received in a recess in the connection plate 33 between the two lugs 45.

The frame 10 has two sidewalls and each of the two sidewalls has a tube 14 with a hole 141 defined therethrough. The two sidewalls located on two outside of the two lugs 45 of the body 40 and a screw 16 extends through the two holes 141 in the two sidewalls of the frame 10, the two lugs 45, the two lugs 32 and the neck portion 24.

When the user lifts the handle 30, the insertion 34 pushes the two terminal plates 49 to contact with each other so as to form the circuit and the bulb 21 lights up. The bulb 21 is off when releasing the handle 30. By this arrangement, the user needs no extra action to light up the bulb 21.

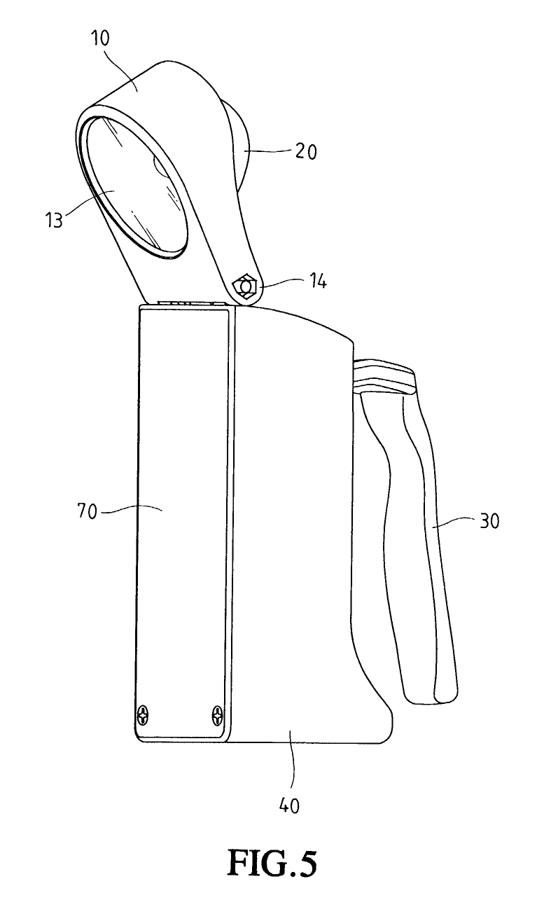

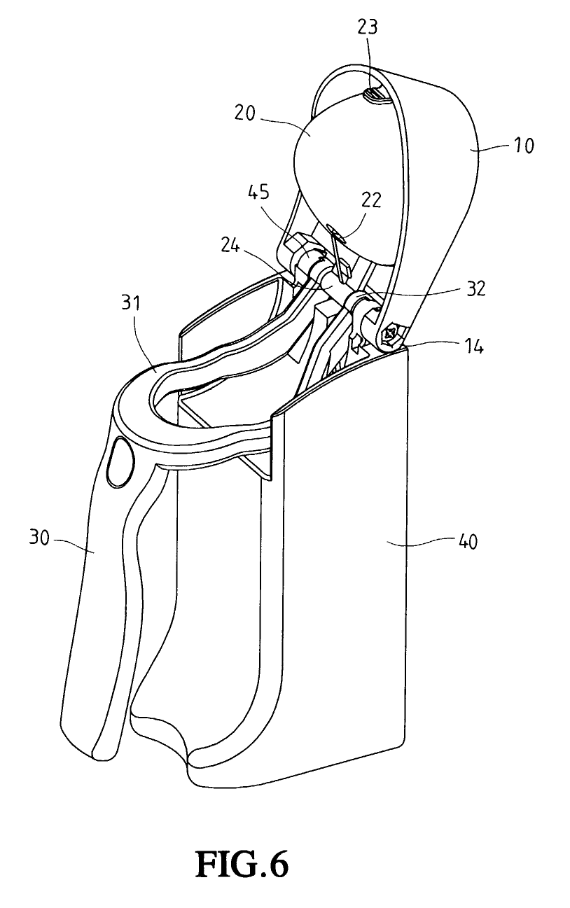

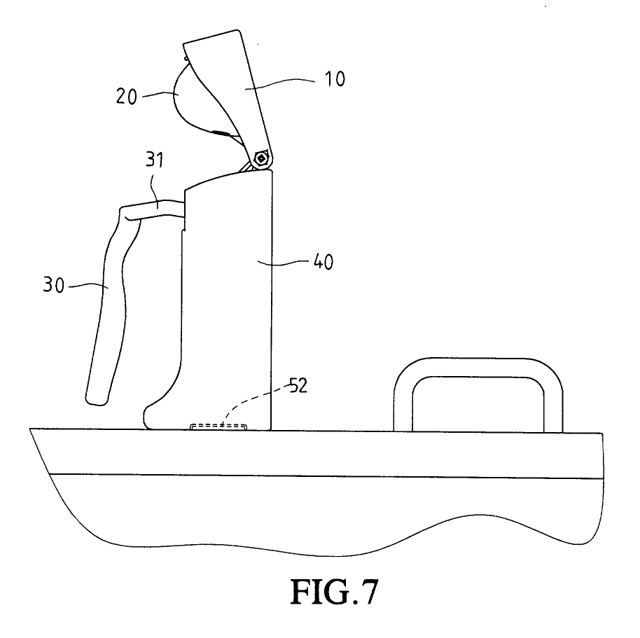

Referring to FIGS. 5 and 6, the light bulb assembly can be pivoted about the screw 16 till the edge 15 of the frame 10 is stopped by the two lugs 45. Therefore, the flashlight assembly can be positioned on a metal surface as shown in FIG. 7 by the magnetic member 52 and the reflection member 20 is pivoted to desired angle such that the user needs not to hold the flashlight assembly. The magnetic member 52 is useful to position the flashlight assembly on a charging base (not shown).

While we have shown and described the embodiment in accordance with the present invention, it should be clear to those skilled in the art that further embodiments may be made without departing from the scope of the present invention.

What is claimed is:

1. A flashlight assembly comprising:
a body having a battery received therein and an end cap assembly connected to a first end of the body, two slots defined through a second end of the body, two terminal plates connected to an inside of the second end of the body and a gap defined between the two terminal plates;
a handle having an engaging portion which is pivotably connected to the second end of the body and two insertions extending through the two slots, one of the two insertions located below the two terminal plates, and
a light bulb assembly pivotably connected to the engaging portion of the handle.

2. The flashlight assembly as claimed in claim 1, wherein an end cap assembly includes a retaining plate and an end cap, a magnetic member positioned between the retaining plate and the end cap.

3. The flashlight assembly as claimed in claim 2, wherein the end cap has two slits defined in an inside of the end cap, the retaining plate having two flanges which are inserted in the two slits, the magnetic member retained between the two flanges.

4. The flashlight assembly as claimed in claim 2, wherein the end cap has a plurality of charging holes defined therethrough.

5. The flashlight assembly as claimed in claim 1, wherein the light bulb assembly includes a reflection member with a bulb connected thereto and a frame which is detachably connected to the reflection member.

6. The flashlight assembly as claimed in claim 5 wherein the reflection member has a resilient tab which has a stepped portion, a protrusion extending from an inside of the frame and engaged with the stepped portion of the resilient tab.

7. The flashlight assembly as claimed in claim 5, wherein two lugs extend from the second end of the body and the engaging portion of the handle and an extension portion of the reflection member are pivotably connected between the two lugs by a screw.

8. The flashlight assembly as claimed in claim 7, wherein the frame has two sidewalls and each of the two sidewalls has a hole defined therethrough, the two sidewalls located on two outside of the two lugs of the body and the screw extending through the two holes in the two sidewalls of the frame.
